(19) United States
(12) Patent Application Publication
(10) Pub. No.: US 2002/0051843 A1
(43) Pub. Date: May 2, 2002

(54) High-foaming, stable modified whey protein isolate

(76) Inventors: Lois A. Baker, Jordan, MN (US); Martin E. Davis, Tonka Bay, MN (US); Pauline M. Olson, Savage, MN (US); Laurie Nelson, Minneapolis, MN (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 09/977,320

(22) Filed: Oct. 15, 2001

Related U.S. Application Data
(63) Continuation of application No. 09/624,053, filed on Jul. 24, 2000.

(51) Int. Cl. A23C 17/00

(52) U.S. Cl. 426/583; 426/551; 426/564

(57) ABSTRACT

A modified whey protein isolate having the ability to fully replace egg whites in many food applications requiring foaming is prepared by a process which involves heat treating to obtain a unique balance of overrun and foam stability properties. The process entails heating an aqueous solution of whey protein isolate at from 70° C. to 85° C., and can include holding at this temperature and pH adjustment prior to heating to obtain the desired properties. Food mixes employing the modified whey protein isolate and processes for making food products employing the modified whey protein isolate are also provided.

### BACKGROUND OF THE INVENTION

The invention relates to a method for improving the foaming properties of whey proteins and to modified whey proteins so improved. In addition, the invention enables the use of these modified whey proteins in processes and products improved over the same products employing unmodified whey protein isolates.

Foams, such as produced by egg whites, are a necessary ingredient in many food products, such as cakes, e.g., angel food, meringues, mousses, whipped toppings, confections and the like. These foams are essentially colloidal systems in which tiny air bubbles are dispersed in an aqueous continuous phase. Foam formation can be hindered by lipids, pH, temperature and reducing agents. While foams of egg whites produce high overruns and are quite stable throughout baking, foams based on whey protein have lacked these desirable characteristics. Indeed, successful replacement of egg white protein with whey protein has been difficult.

Several researchers have attempted to replace egg whites with whey proteins with less than satisfactory results. See, for example, Arunepanlop et al, J. Food Science; Vol. 61, No. 5; 1996, wherein attempts were made to replace from 25 to 50% of egg white protein with whey protein isolate. As a preliminary to testing, they heat treated the whey protein samples to 55° C. for 30 minutes. Complete replacement was not attempted. Also, see DeVilbiss et al., Food technology; Vol. 28, No. 3; March 1974. They prepared a special isolate to replace egg white protein. At equal protein levels, the isolate performed poorly in the environment of cake baking where they “are subjected to high heat.”

These references point out that angel food cake preparation provides a considerably stressing environment for whey protein foams. Indeed, angel food cake is one of the most complex food systems based on egg white foam. Most prior art attempts to replace egg white proteins in angel food cake could achieve only partial replacement without seriously affecting cake properties.

The disclosure of Chang, et al., in U.S. Pat. No. 4,267,100, is further indicative of the problems associated with the attempted use of whey protein as a substitute for egg whites. Therein, after describing a number of procedures for modifying whey to enable better performance, they propose a process that involves increasing solution pH followed by decreasing solution pH to separate insoluble materials from soluble materials. A resulting soluble protein is a modified whey protein suitable for use as an egg white substitute, but having a low and modified protein content. A resulting insoluble protein is also of different composition from the starting whey and is further modified by hydrolyzing it to render it soluble and make it useful as an egg white substitute in meringues and angel food cake. Angel food cakes were prepared with modified whey protein products from both the soluble and hydrolyzed-insoluble fractions at replacement levels of only up to 10% of the egg whites. It is also noted that the egg whites used in the comparison were dried egg whites—reduced in functionality due to processing.

In U.S. Pat. No. 2,695,235, to deGoede, a modified whey is prepared from dried sweet whey by elevating and then reducing the pH in aqueous solution. The material was then centrifuged to separate out the supernatant, which was dried for use. This product was compared along with a commercial sample according to U.S. Reissue Pat. No. 27,806 and dried egg whites in Example 6 of U.S. Pat. No. 4,267,100. The product of the latter patent was deemed to be superior.

In U.S. Pat. No. 4,214,009, Chang, et al., disclose an egg white substitute containing whey protein concentrate and carboxymethylcellulose (CMC). In the course of their description, they note that commercially available whey protein concentrate, such as an ultrafiltered whey containing 50% protein, will not effectively replace large amounts of egg albumen in cakes. They point out that an economic advantage could be gained by using the less expensive whey protein concentrate as a substitute for the albumen, but that the cakes produced evidenced lower cake volume, especially at a weight/weight replacement of albumen with concentrate and weaker texture particularly when albumen replacement is above 50%. They noted that their testing showed that in general, only small amounts of egg albumen, i.e., up to 25%, could be replaced with the whey protein concentrate and that such use had not previously been considered to be generally commercially successful. Their preferred replacement product contained only 50% protein but added CMC—clearly, nutritionally inferior to egg white. Moreover, because they intend to replace egg white on an equal protein basis, any products they produce will have a higher amount of solids, including non-protein solids. They specifically indicate that the replacement of egg albumen is intended to relate to the areas of use of albumen in structure forming in bakery goods and not as a whippable system capable of forming freestanding foams in the manner of egg albumen. In this description, “bakery goods” are not intended to include meringues and angel food cakes. Again, the problems in achieving an egg white replacement suitable for angel food cakes is highlighted. Arunepanlop et al., supra, utilized methylcellulose as an additive in their attempts to replace up to 50% egg white in angel food cakes.

In U.S. Pat. No. 4,107,334, Jolly discusses the preparation of functional protein by heat denaturing impure natural protein selected from the group of whey, microbial and vegetable protein and then enzymatically hydrolyzing it. Protein prepared from yeast was used with only partial success as a partial egg white replacement in angel food cake. In U.S. Pat. No. 4,029,825, Chang treats cheese or vegetable whey with sodium lauryl sulfate to prepare a partial egg white replacer. In U.S. Pat. No. 4,294,864, Kulp, et al., discusses the preparation of “high-ratio cakes” wherein the use of chlorinated flour is eliminated through the use of starch and a protein such as whey in the batter. However, the recipe for angel food cake still employs egg whites in the traditional recipe.

With this as background, it is clear that the art is in need of an egg white protein replacement capable of providing necessary foaming properties to a variety of food products, including the especially-demanding environment of angel food cake preparation. The desirable combination of properties has not been possible even though the art has been investigating this technology for over fifty years and attempted a wide variety of alternative techniques.

### SUMMARY OF THE INVENTION

It is an object of the invention to provide improvements in the replacement of egg white protein in food applications requiring foaming.

It is an object of the invention to provide a process for preparing an egg white protein replacement having suitable functionality and clean taste for food applications requiring foaming, the product of that process, food mixes containing it and a method of preparing foods utilizing it.

It is a more particular object of the invention to provide modified whey protein isolate compositions and processes effective for replacing egg white protein in food applications requiring foaming, especially angel food cake and meringues.

It is yet another object of the invention to provide a process for preparing a composition effective for replacing egg white protein in foods for lactovegetarians.

It is yet another object of the invention to provide a process for preparing a composition effective for replacing egg white protein in foods for individuals having egg protein allergies.

It is a further, particular object of the invention to provide a modified whey protein isolate and processes effective to enable full replacement of egg white protein in angel food cake, meringue, and other food products requiring a foam structure.

These and other objects are accomplished by the invention, by improvements which provides a modified whey protein isolate, a process for making a modified whey protein isolate, food mixes employing the modified whey protein isolate and processes for making food products employing the modified whey protein isolate.

The process for preparing the modified whey protein isolate comprises: preparing an aqueous solution of whey protein isolate at a pH within the range of from about 5 to about 8, preferably 6.5 to 7.5; and heating the solution of whey protein isolate to a temperature within the range of above 60 up to about 80° C. In one aspect, the concentration of the solution of whey protein isolate prior to heating is in the range of from about 5 to 20% by weight, preferably from 10 to 15%. In another, following heating the solution is held at a temperature within the range of from 60 to 85° for from 1 to 10 minutes. Preferably, the solution is heated to a temperature of from above 70° to below 80° C., and, following heating the solution is held at a temperature within the range of from 60 to 85° for from 1 to 5 minutes.

In a preferred aspect the modified whey protein isolate is characterized by being capable of whipping to an overrun of at least 900 and having a stability of at least 94%, preferably to an overrun of from 1000 to 1400 and having a stability of at least 95%. In another aspect, the product will be characterized by a drip value of from 10 to 30 minutes.

Typical of food mixes of the invention are those employing a dried modified whey protein isolate defined above and a carbohydrate. The mix can contain one or more separately packaged portions, with an angel food cake mix being most preferred and a highly advantageous use of the unique modified whey protein isolate of the invention.

Other preferred aspects are described below.

### BRIEF DESCRIPTION OF THE DRAWINGS

The invention will be better understood and its advantages more apparent from the following detailed description, especially when read in light of the accompanying drawings, wherein:

FIG. 1 is a graph showing foam overrun and stability of egg white and whey protein isolate (WPI);

FIG. 2 is a graph showing foam overrun for WPI solutions modified by heat treating;

FIG. 3 is a graph showing foam stability for WPI solutions modified by heat treating;

FIG. 4 is a photograph showing foams prepared from egg white, whey protein isolate and whey protein isolate prepared in accordance with the invention, following baking;

FIG. 5 is a photograph showing foams prepared from whey protein isolate heat treated at various temperatures, following baking;

FIG. 6 is a photograph showing baked foams prepared from a control whey protein isolate and several modified whey protein isolates heat treated at 60° C. and held there for various times;

FIG. 7 is a photograph showing baked foams prepared from a control whey protein isolate and several modified whey protein isolates heat treated at 70° C. and held there for various times;

FIG. 8 is a photograph showing baked foams prepared from a control whey protein isolate and several modified whey protein isolates heat treated at 75° C. and held there for various times;

FIG. 9 is a photograph showing baked foams prepared from a control whey protein isolate and several modified whey protein isolates heat treated at 80° C. and held there for various times;

FIG. 10 is a photograph showing baked angel food cakes prepared from egg whites and whey protein isolate heat treated according to the invention; and

FIG. 11 is a photograph showing baked angel food cakes prepared from egg whites and whey protein isolate heat treated according to the invention.

### DETAILED DESCRIPTION OF THE INVENTION

The invention enables the use of modified whey protein isolates in a variety of food systems requiring a foaming component usually satisfied by the use of egg white protein. Egg white, regardless of whether referred to as egg white protein, egg albumen or dried egg white, is effectively replaced in all of those products known to require the use of egg white for foaming. In particular, the food products identified in the above references are all incorporated by reference. The invention is especially advantageous as compared to whey protein products previously suggested for these purposes because it is surprisingly functional in the preparation of angel food cakes, even at 100% replacement.

Whey protein isolates (WPI) can be obtained from commercial-scale fractionation of cheese whey by various processes, including ion-exchange processing using cationic and/or anionic resins selected for the intended functionality of the isolate. (Pearce, R. J., 1992, Whey protein recovery and whey protein fractionation, In Whey and Lactose Processing, J G Zadow, Ed., Elsevier, London, 271-316.) Commercial WPI products issued from ion-exchange processing, such as BIPRO™ (Davisco Foods International, LeSueur, Minn.), are characterized by a high protein content (>94% w/w), low ash content (<3%), traces (<1%) of fat and lactose. The protein distribution of a typical WPI shows 73% β-lactoglobulin, 15% α-lactalbumin, and the remaining 12% is composed of bovine serum albumin, immunoglobulins and caseinomacropeptide.

BiPRO™ whey protein isolate is the preferred source of whey protein isolate for use in the invention and is available from Davisco Foods International, Inc., with offices at 11000 W. 78th Street, Suite 210, Eden Prairie, Minn. 55344. The preferred BiPRO™ whey protein isolate has a (PDCAAS) Protein Digestibility Corrected Amino Acid Score of 1.14. The fat and lactose levels are less than 1%. The BiPRO™ whey protein isolate is prepared by ion-exchange technology, and contains at least 91% (w/w) protein. Preferably, the whey protein isolate employed according to the invention will contain at least 60% β-lactoglobulin and preferably at least 80%, e.g., 65-70%, β-lactoglobulin, with the remaining comprising α-lactalbumin, serum albumin, immunoglobulins and caseinomacropeptide. BiPRO™ is essentially undenatured and is fully soluble over the pH range 2.0 to 9.0, and has the following analysis:

| Analysis* | Specification | Typical Range | Test Method |
|---|---|---|---|
| Moisture (%) | 5.0 max. | 4.7 ± 0.2 | Vacuum Oven |
| Protein, dry basis | 95.0 min. | 97.5 ± 1.0 | Combustion |
| (N × 6.38) (%) | | | |
| Fat (%) | 1.0 max. | 0.6 ± 0.2 | Mojonnier |
| Ash (%) | 3.0 max. | 1.7 ± 0.3 | Gravimetric |
| Lactose (%) | 1.0 max. | <0.5 | by difference |
| pH | 6.7-7.5 | 7.0 ± 0.2 | 10% Sol. @ 20° C. |

*All results reported “AS IS” basis except where noted.
Standard Methods for the Examination of Dairy Products, 16th Edition.

As noted, whey protein isolates other than BiPRO™ can be employed and where used preferably have similar analyses to that above, varying by from 0 to 25%, e.g., from 5 to 10%, or less, from the above Typical Range values.

A suitable whey protein isolate can be produced having similar properties through a selective ion exchange process that selects the primary functional proteins—beta-lactoglobulin and alpha-lactalbumin—for concentration and spray drying. Such a process is described in U.S. Pat. No. 4,154,675 to Jowett, et al., and U.S. Pat. No. 4,218,490 to Phillips, et al.

On a more detailed analysis of BiPRO™ whey protein isolate, the following is found for each 100 grams of whey protein isolate:

| Component | |
|---|---|
| Calories | 377 |
| Calories From Total Fat | 5 |
| Total Fat (g) | 0.5 |
| Saturated Fat (g) | 0.2 |
| Cholesterol (mg) | 10 |
| Sodium (mg) | 600 |
| Potassium (mg) | 140 |
| Total Carbohydrates (g) | 0 |
| Dietary Fiber (g) | 0 |
| Sugars (g) | 0 |
| Protein (g) | 93 |
| Vitamin A (IU) | n.d. |
| Vitamin C (mg) | 2.0 |
| Calcium (mg) | 100 |
| Iron (mg) | 5 |
| Phosphorus (mg) | 50 |
| Magnesium (mg) | 10 |
| Ash (g) | 1.5 |
| Moisture (g) | 5 |

And, to determine the amino acid profile of the preferred BiPRO™ whey protein isolate, samples were subjected to drying for 24 hours in a dessicator over phosphorous pentoxide and sodium hydroxide. The dry samples were hydrolyzed in HCl vapor (6N HCl with 1% phenol and 0.5% sodium sulfite) under Argon atmosphere. After 20 hours of hydrolysis at 110 degrees Celsius, the samples were dissolved in 200 ul of Beckman Na—S sample buffer. This acid hydrolysis method destroys tryptophan.

Analyses were conducted on a Beckman 6300 Amino Acid Analyzer. Norleucine was used as an internal standard. The analysis showed the following:

| | Grams Amino Acid Per | |
|---|---|---|
| Amino Acid | 100g protein | 100g powder |
| Alanine | 7.6 | 7.01 |
| Arginine | 2.0 | 1.84 |
| Aspartate | 10.1 | 9.31 |
| Cysteine/Cystine | 4.3 | 3.96 |
| Glutamine | 14.3 | 13.18 |
| Histidine | 1.6 | 1.48 |
| Isoleucine * | 5.4 | 4.98 |
| Leucine * | 13.7 | 12.63 |
| Lysine * | 9.6 | 8.85 |
| Methionine * | 2.4 | 2.21 |
| Phenylalanine * | 3.1 | 2.86 |
| Proline | 4.5 | 4.14 |
| Serine | 4.90 | 4.52 |
| Threonine * | 5.30 | 4.89 |
| Tyrosine | 2.90 | 2.67 |
| Valine * | 5.60 | 5.16 |
| Totals | 97.3 | 89.69 |

* Essential Amino Acids

Again, when whey protein isolates other than BiPRO™ are employed, they preferably have similar analyses to that above, varying by from 0 to 25%, e.g., from 5-10%, or less, from the above values.

A modified whey protein isolate having the ability to fully replace egg whites in many food applications requiring foaming is prepared by a process which involves heat treating to obtain a unique balance of overrun and foam stability properties. The process entails heating an aqueous solution of whey protein isolate at from 70 to 85° C., and can include holding at this temperature and pH adjustment prior to heating to obtain the desired properties.

The process of preparing the modified whey protein isolate of the invention involves: preparing an aqueous solution of whey protein isolate at a pH within the range of from about 5 to about 8, e.g., from 6.5 to 7.5, and heating the solution of whey protein isolate to a temperature within the range of above 60 up to less than about 85° C., more narrowly from 70 to 80° C. The solution of whey protein isolate prior to heating can be any which is effective for processing, typically in the range of from about 5 to 20% by weight. A more narrow concentration of whey protein in the solution for heat processing is in the range of from about 10 to 15% by weight to the extent necessary, the pH of the solution can be adjusted to a desired value with the addition of cream of tarter, calcium chloride, a weak food acid or mildly acid or alkaline buffer salts, and like mild food additives capable of increasing or decreasing the pH of the solution. Where the water is not distilled and/or deionized pH adjustment is likely necessary for reproducible results.

Following heating, the solution is held at a temperature within the range of from 60 to 85° for from 1 to 10 minutes. More narrowly, following heating the solution is held at a temperature within the range of from 60 to 85° for up to 5 minutes. A preferred laboratory method for heating is to place about 200 ml of a whey protein isolate solution in a 400 ml beaker and place the beaker in a first, hot bath at a temperature of 95° C. A thermometer is placed in the beaker and the contents are agitated and monitored over the time taken to heat it to the desired temperature. Upon reaching the desired temperature, the beaker is removed from the first bath and placed in a second, cooling bath maintained at about 10-15° C. until the temperature reaches 25° C. At this time the beaker is removed from second bath and the resulting modified whey protein isolate is ready for use. The conditions are balanced within these ranges to provide modified whey protein isolate according to the invention having a unique combination of the important properties discussed below.

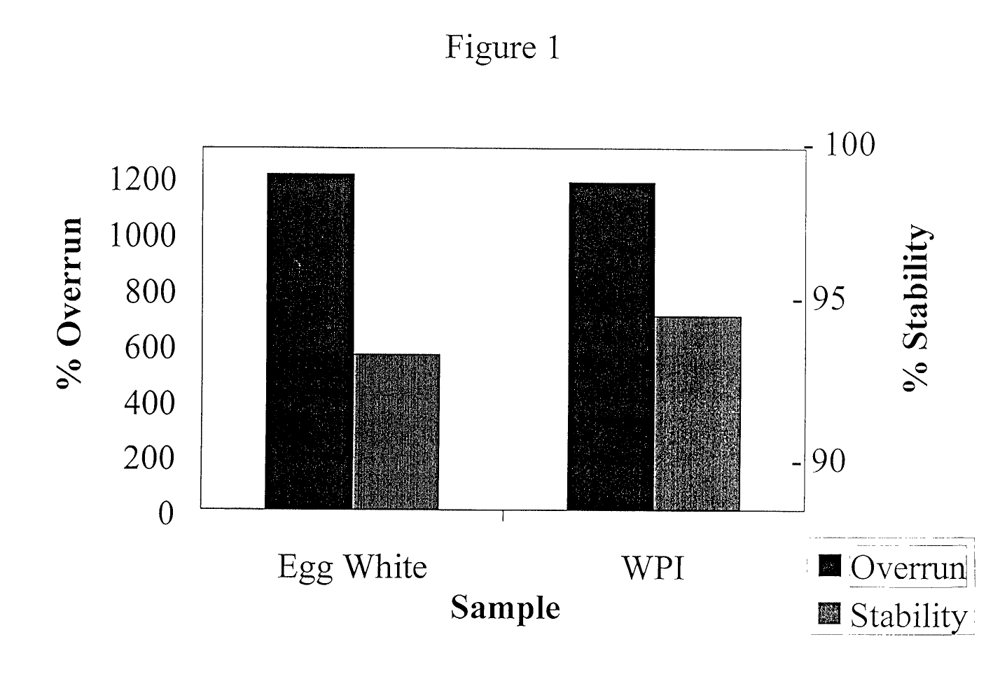

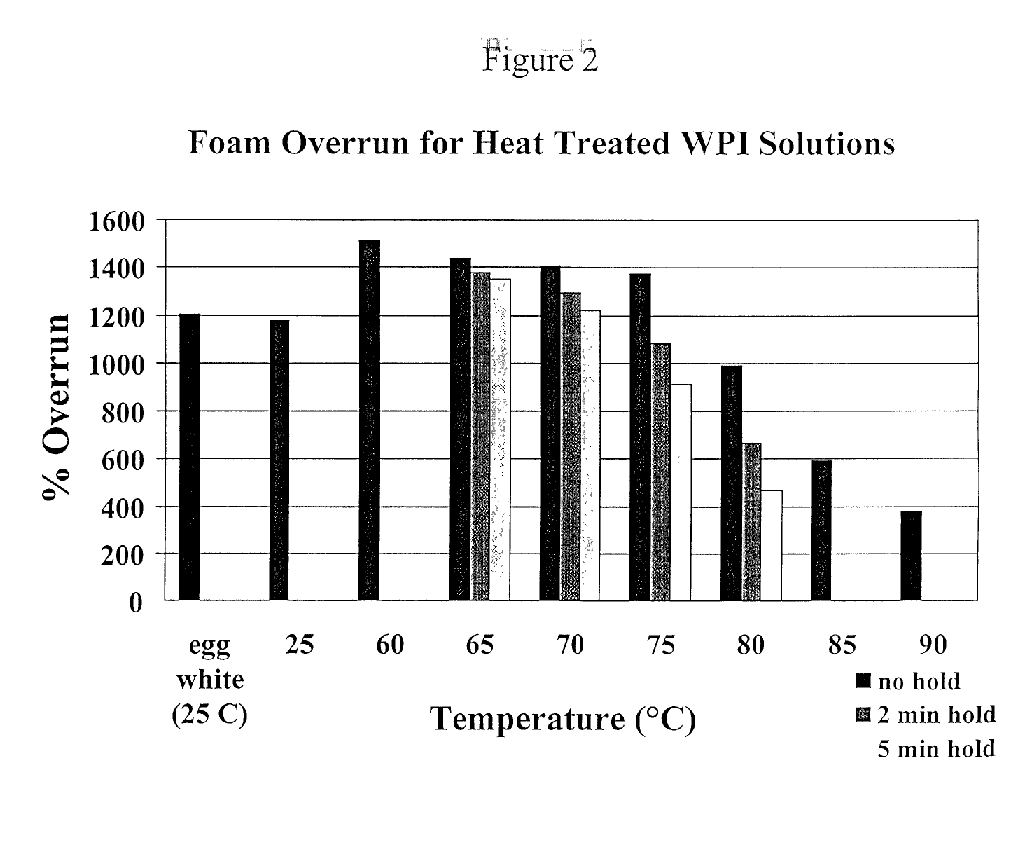

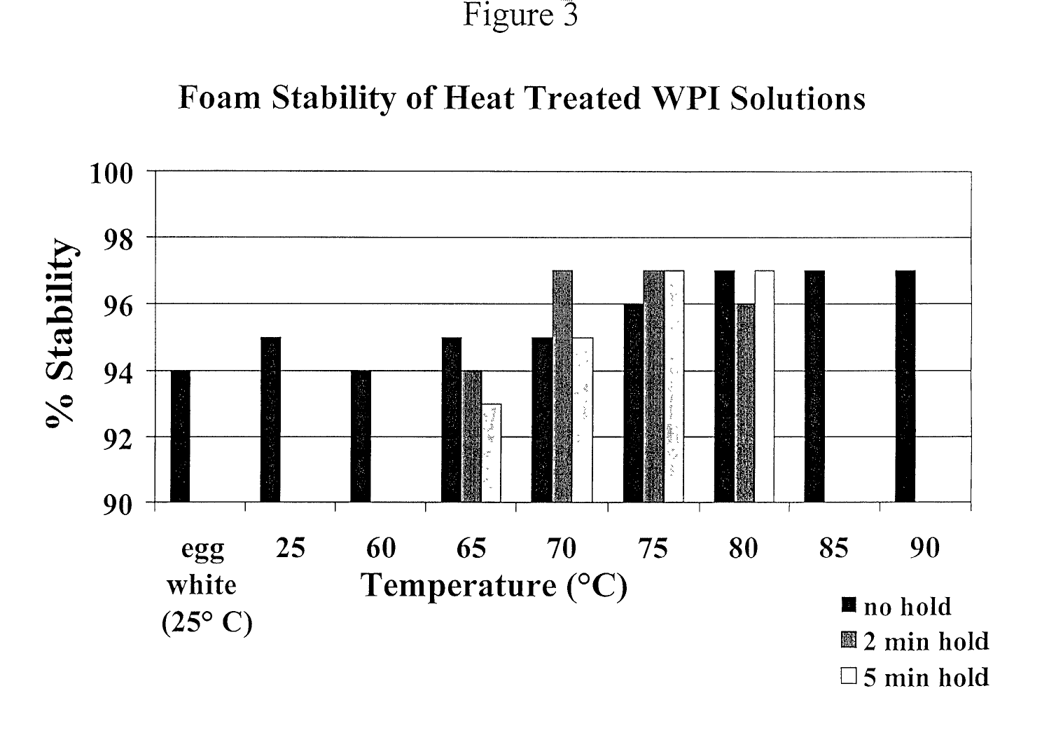

The modified whey protein isolate will have overrun and stability properties similar to egg white protein, either fresh or spray dried. FIG. 1 compares overrun and foam stability for egg white protein and whey protein isolate, untreated. The whey protein isolate samples were tested by the procedures given below, while the procedure for the egg white protein was modified to provide a 5 minute whip, optimum for it. Preferably, the modified whey protein isolate of the invention will be characterized by being capable of whipping to an overrun of at least 900 and having a stability of at least 94%. Preferred overruns will be at least 1000 up to about 1400, with 1100 to 1300 being a desirable value for many applications. FIG. 2 compares the overruns achieved for egg white, whey protein isolate and various modified whey protein isolate samples subjected to heat treatments indicated in the figure. Preferred foam stability will be 95% or more. FIG. 3 compares the foam stabilities achieved for egg white, whey protein isolate and various modified whey protein isolate samples subjected to heat treatments indicated in the figure.

Overrun is a measure of how much air is incorporated into a foam and for the purposes of the modified whey protein isolate of the invention is measured by the following procedure:

1. Prepare 100 ml whey protein isolate solution, (11.3% w/w).

2. Whip for 20 minutes high speed, e.g., on a Kitchen-Aid mixer.

3. Calculate

$$\% foam overrun = \frac{weight 100 ml liquid - weight 100 ml foam}{weight 100 ml foam} \times 100$$

Stability is a measure of how stable the foam is prior to baking and for the purposes of the invention is measured by the following procedure:

1. Prepare 100 ml foam, weigh foam and hold at room temperature for 30 minutes.

2. Drain any liquid and weigh foam.

3. Calculate

$$\% foam stability = \frac{weight of foam after 30 min}{weight of foam before holding} \times 100$$

Foam stability is important as tested and also in its ability to survive baking and for the purposes of the invention is measured by the following procedure:

1. Place 7 grams foam in foil baking cup.

2. Bake at 350° F. for 15 min.

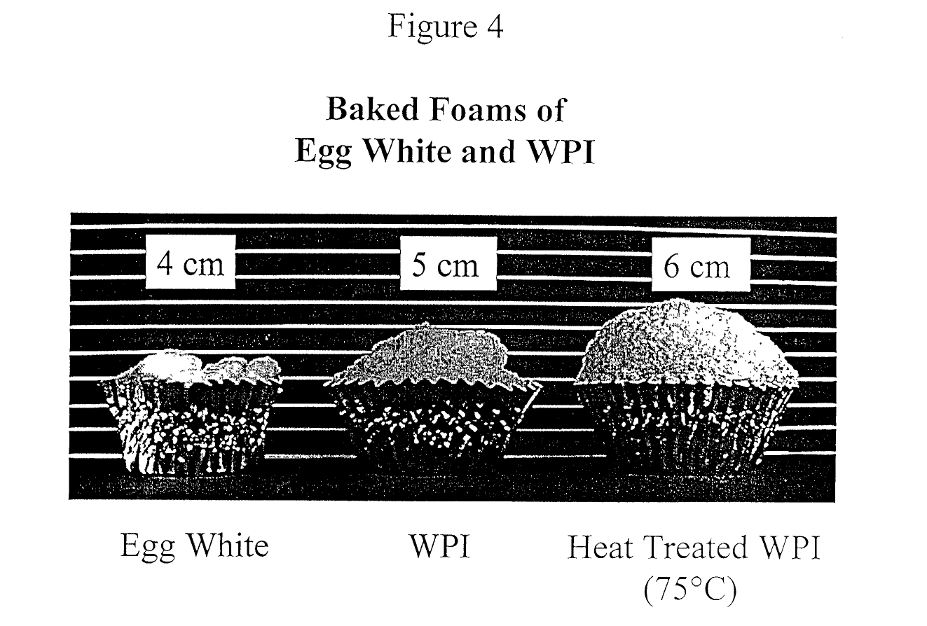

It can be seen from FIGS. 1-3, that whey protein isolate—as is—compares favorably with egg white protein in terms of overrun and foam stability. In FIG. 4, a foam baking test compares the foam performance achieved for egg white, whey protein isolate and modified whey protein isolate samples subjected to heat treatment at 75° C., with no hold time. Again, in this application, the unmodified whey protein isolate appears to operate effectively for the purpose of foaming. However, when the unmodified whey protein isolate is compared to egg white in the preparation of an angel food cake, the cakes fell significantly at the end of baking and had large air cells that were “lacy” in appearance. These cakes with unmodified whey protein isolate were judged unsatisfactory, and unmodified whey protein isolate was considered unsatisfactory, as had already been documented in the prior art, as a full replacement for egg white.

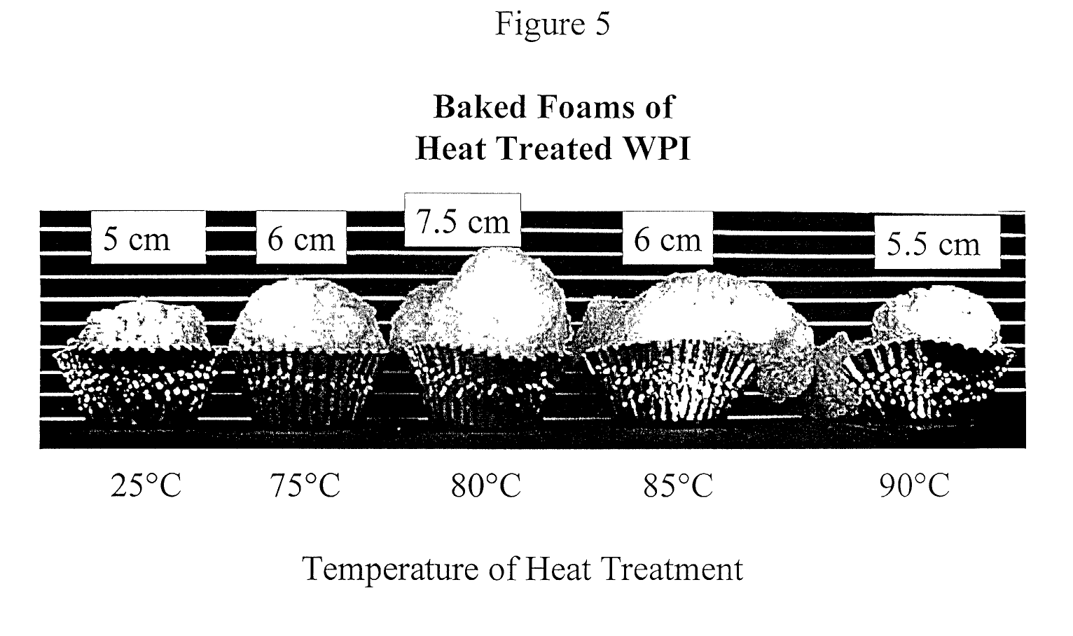

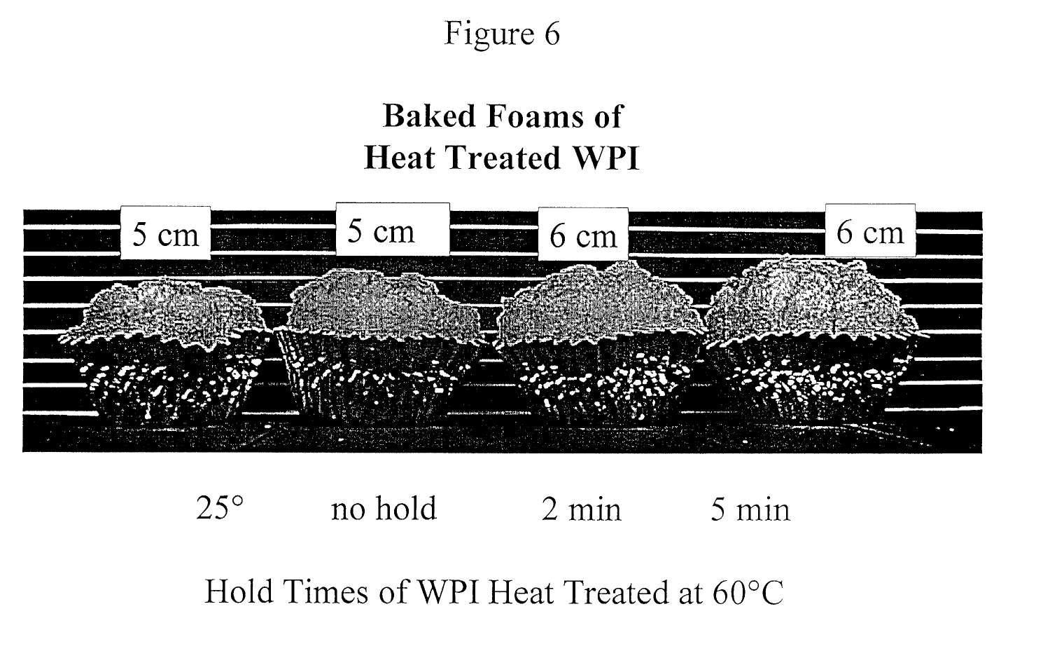

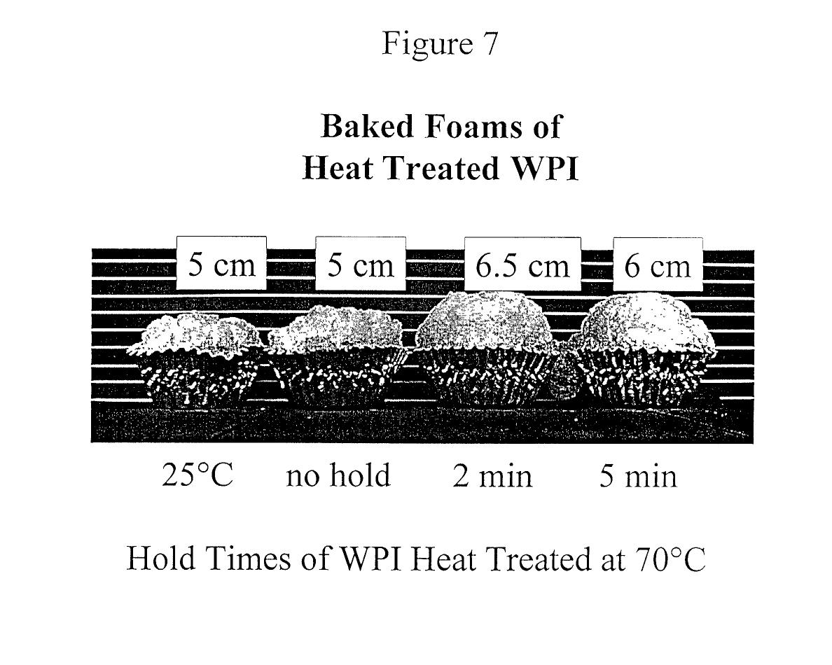

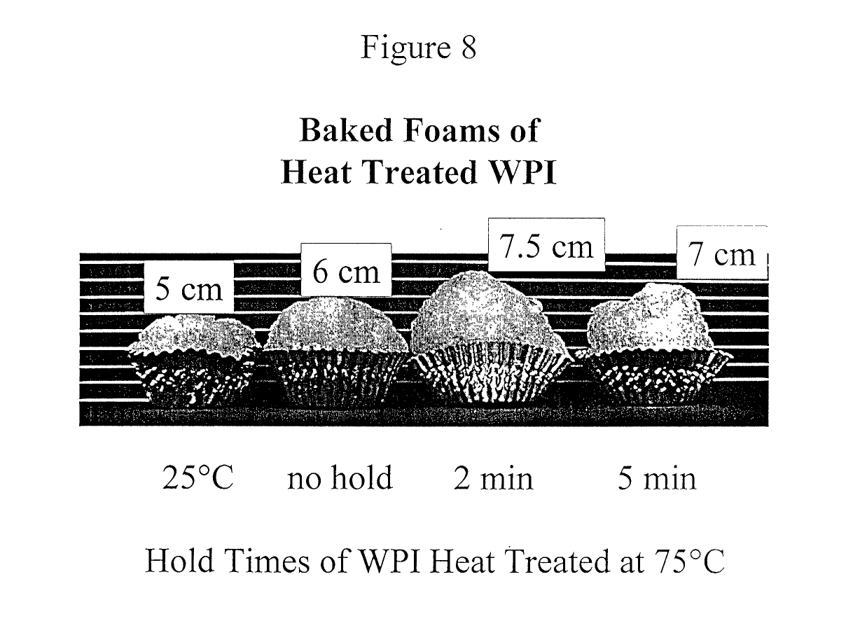

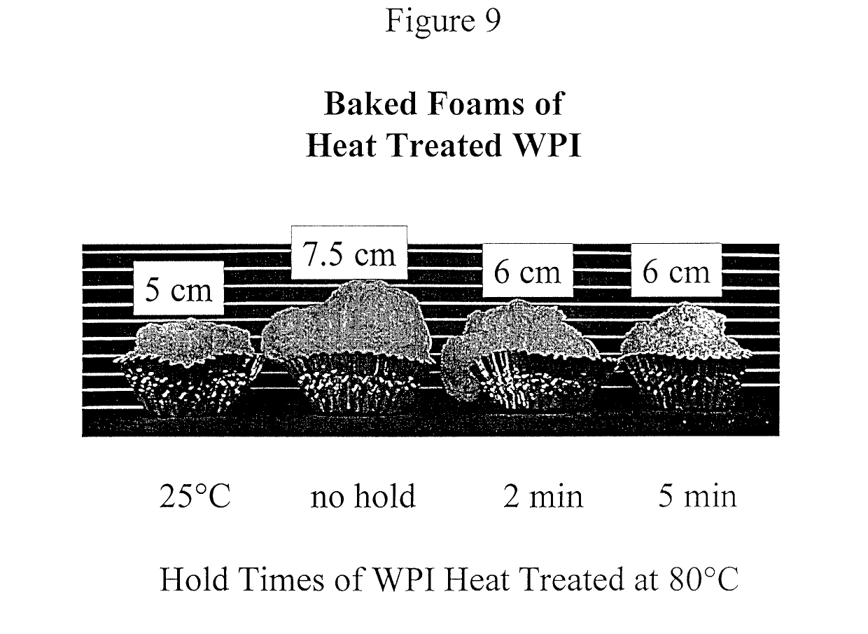

The photographs in FIGS. 5 through 9 show the results of comparisons of baking tests on a foam prepared from an unmodified (25° C.) and foams prepared from modified whey protein isolate at various times and temperatures indicated. The foams prepared at 70 and 75° C. were judged to be particularly good in terms of foam height and shape.

Another factor which has been found to correlate with preferred test samples is the achievement of a drip time within the range of from 10 to 30 minutes, preferably from about 12 to about 20 minutes. Drip time can be measured by preparing a foam as above, placing the foam in a funnel and observing the time required for the first drop to fall from the funnel into a beaker.

Following preparation, the modified whey protein isolate can be utilized in its liquid form, already at the desired concentration for incorporation into food products, or can be dried such as by freeze drying or spray drying to enable storage of the modified whey protein isolate in dry form. The drying should be monitored to control loss in functionality of the product as, for example, is done in the drying of egg whites. Drying will enable use of the modified whey protein isolate in a variety of dry mixes—packaged either mixed or separated from the other components of the mix. Mixes can be provided including the modified whey protein isolate of the invention and other ingredients necessary for the preparation of cakes, e.g., angel food, meringues, mousses, whipped toppings, confections and the like.

Typical food mixes will comprise at least one carbohydrate component in addition to the modified whey protein isolate of the invention. It is typical to package the carbohydrate component separately from the modified whey protein isolate portion, e.g., in separate pouches. The carbohydrate portion will preferably comprise a sugar such as sucrose or other nonreducing sugar. Reducing sugars, such as fructose, dextrose, high fructose corn syrup and other corn syrups and starch hydrolysates can be employed with the recognition of their properties, e.g., their tendency to cause browning. The flour component will be selected based on conventional usage and can be from wheat, corn, rice, potato, barley, oats, and other starch-containing plant components, particularly grains and tubers.

Other ingredients may also be employed to impart their characteristic effects to the compositions of the present invention. Typical of such ingredients are flavoring agents, colorants, vitamins, minerals, and the like. Various flavors can be employed in the mix for addition to the ingredients before or during final mixing. Suitable flavoring agents can be employed to impart vanilla, cream, chocolate, coffee, maple, spice, mint, butter, caramel, fruit and other flavors.

For some formulations and flavors, it is desirable to add stabilizers of a type and in an amount sufficient for the purpose. Stabilizers can also be added for the purpose of enhancing smoothness and decreasing syneresis of high moisture content final products intended for long periods of storage. Typical of the stabilizers, are proteinaceous materials such as gelatin, pectin, natural and synthetic hydrophilic colloids, such as carboxymethyl cellulose, vegetable gums such as locust bean gum, carob bean gum, guar gum, carrageenans and alginates and various starches and modified starches in addition to those employed as a major starch ingredient. Also, other ingredients such as leavening agents, texture modifiers, cream of tarter, alkali metal and alkaline earth carbonates, bicarbonates, chlorides and salts of organic food acids. In addition, emulsifiers are often employed, especially to improve batter performance during preparation and baking.

In the case of angel food cake, the food mix will contain two separate components, one whippable portion will contain the modified whey protein isolate of the invention and one batter component will contain flour. A number of other ingredients will be employed as called for by any number of known recipes. In this regard, the formulations of the examples which follow and all of the references cited above are incorporated herein by reference for specific examples of angel food cake ingredients and recipes. It is noted that normally angel food cake will be baked at about 375° F. for about 35-40 minutes, until done. However, according to the present invention, baking time is decreased to about 25 minutes by baking the angel food cake batter at above 425° F. to about 450° F.

The following Examples are provided to further illustrate and explain a preferred form of the invention and are not to be taken as limiting in any regard. Unless otherwise indicated, all parts and percentages are by weight.

### EXAMPLE 1

This example describes the preparation of a modified whey protein isolate according to the invention. BIPRO™ whey protein isolate is solubilized in distilled water to a concentration of 11.3% by weight of the final solution. This provides a protein content (10.5%), equivalent to a 12.5% by weight solution of egg white. The solution (200 ml) is poured into a 400 ml beaker and is heated in a boiling water bath with moderate stirring until a thermometer in the beaker indicates a temperature of 75° C. has been reached. Following heating the solution, it is not held this temperature as in other embodiments, but is removed from the boiling water bath and placed in a second, cooling bath maintained at about 10-15° C. until the temperature reaches 25° C. At this time the beaker is removed from second bath and the resulting modified whey protein isolate is ready for use.

### EXAMPLE 2

This example describes the preparation of an angel food cake with the modified whey protein isolate prepared in Example 1. The ingredients were prepared in two portions as follows:

Parts
By Weight

Part A.

| | |
|---|---|
| Water | 42.0 |
| Sugar | 19.3 |
| Modified whey protein isolate | 6.0 |
| Cream of Tartar | 0.6 |
| Flavor | 0.2 |
| Fumaric Acid | 0.1 |

Part B.

| | |
|---|---|
| Sugar | 15.6 |
| Flour | 10.0 |
| Wheat Starch | 5.1 |
| Leavening | 1.1 |

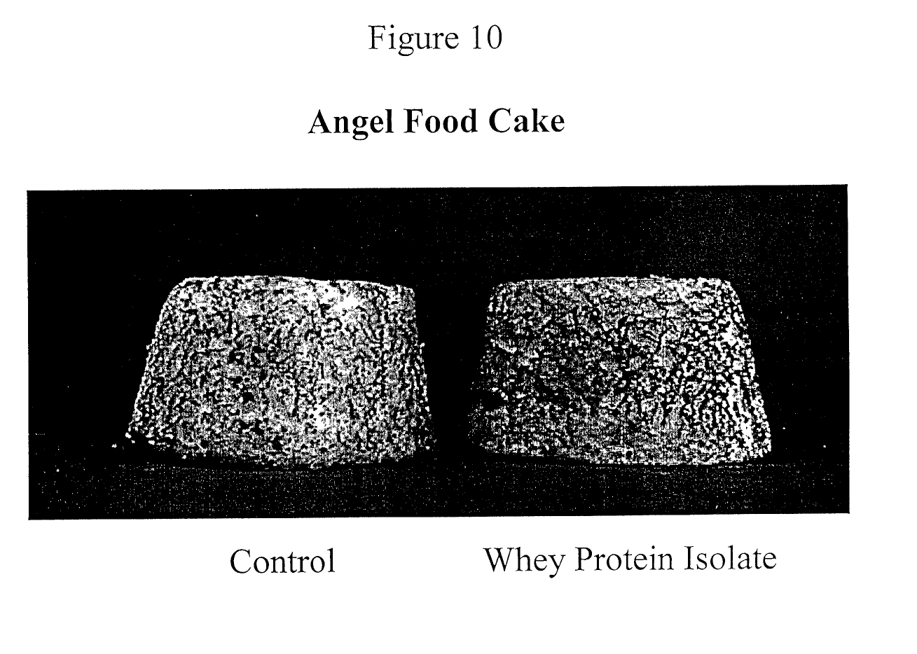

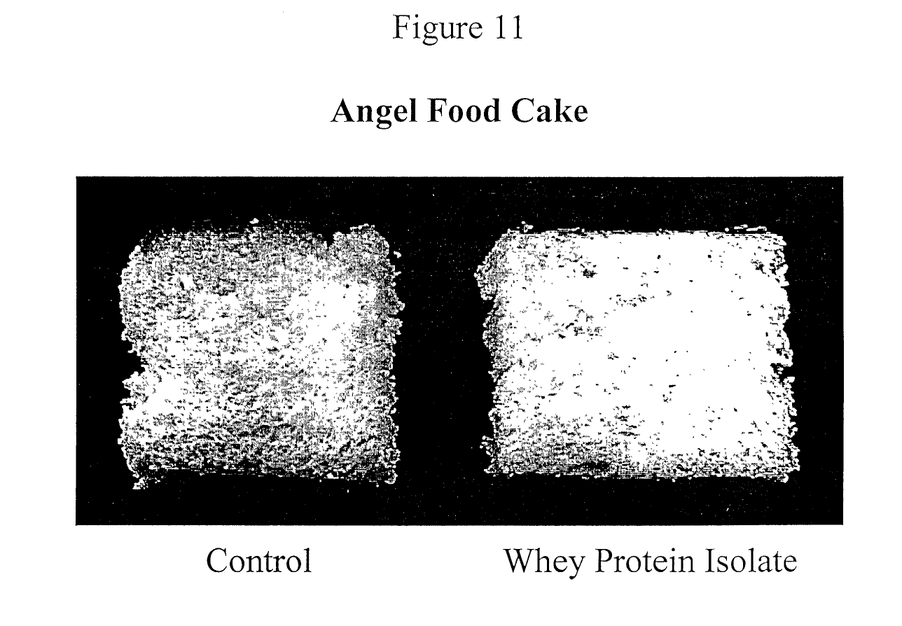

The modified whey protein isolate, cream of tarter and water were placed in a Kitchen Aid mixing bowl and mixed on low speed with a whip attachment for 2 minutes. The bowl was then scraped and the contents mixed for an additional time necessary to form soft peaks—about 4-6 minutes. Then the sugar and flavor of Part A were added slowly with continued mixing, but at high speed, for 1-2 minutes, as needed for complete incorporation. The Part B ingredients were then blended together and sifted into the mixing bowl until just blended in. The resulting batter was poured into a conventional angel food cake ring pan and baked at 450° F. for about 25 minutes, until done. An identical cake except for the replacement of egg whites was prepared. The results as they appeared from the outside and after cutting, photographed and reproduced in FIGS. 10 and 11, show the excellent comparison of quality achieved by using a modified whey protein isolate according to the invention as a complete substitute for egg whites.

The above description is intended to enable the person skilled in the art to practice the invention. It is not intended to detail all of the possible modifications and variations which will become apparent to the skilled worker upon reading the description. It is intended, however, that all such modifications and variations be included within the scope of the invention which is seen in the above description and otherwise defined by the following claims. The claims are meant to cover the indicated elements and steps in any arrangement or sequence which is effective to meet the objectives intended for the invention, unless the context specifically indicates the contrary.

1. A process for preparing a modified whey protein isolate comprising:
preparing an aqueous solution of whey protein isolate at a pH within the range of from about 5 to about 8; and
heating the solution of whey protein isolate to a temperature within the range of above 60° C. up to about 80° C.

2. A process according to claim 1 wherein the concentration of the solution of whey protein isolate prior to heating is in the range of from about 5 to 20% by weight.

3. A process according to claim 2 wherein the concentration of the solution of whey protein isolate prior to heating is in the range of from about 10 to 15% by weight

4. A process according to claim 1 wherein, following heating the solution is held at a temperature within the range of from 60° C. to 85° C. for from 1 to 10 minutes.

5. A process according to claim 1 wherein the solution is heated to a temperature of from above 70° C. to below 80° C.

6. A process according to claim 5 wherein, following heating the solution is held at a temperature within the range of from 60° C. to 85° C. for from 1 to 5 minutes.

7. A process according to claim 1 wherein the modified whey protein isolate is characterized by being capable of whipping to an overrun of at least 900 and having a stability of at least 94%, both measured as described above.

8. A process according to claim 7 wherein the modified whey protein isolate is characterized by being capable of whipping to an overrun of from 1000 to 1400 and having a stability of at least 95%.

9. A process according to claim 1 wherein the concentration of the solution of whey protein isolate prior to heating is in the range of from about 10 to 15% by weight, following heating the solution is held at a temperature within the range of from 70° C. to 80° C. for up to 5 minutes and the modified whey protein isolate is characterized by being capable of whipping to an overrun of at least 900, a stability of at least 94% and a drip value of from 10 to 30 minutes when measured as described above.

10. A process according to claim 9 wherein the pH of the solution prior to heating is within the range of from 6.5 to 7.5.

11. A modified whey protein isolate prepared according to the process of claim 1 characterized by being capable of whipping to an overrun of at least 900 and having a stability of at least 94%, both measured as described above.

12. A modified whey protein isolate according to claim 11 characterized by being capable of whipping to an overrun of from 1000 to 1400 and having a stability of at least 95%.

13. A modified whey protein isolate according to claim 11, further characterized by a drip value of from 10 to 30 minutes.

14. A food mix employing a dried modified whey protein isolate defined in claim 11 and a carbohydrate.

15. A food mix employing a dried modified whey protein isolate defined in claim 14, further comprising a leavening agent.

16. A food mix for preparing an angel food cake comprising two separately packaged components: one containing a dried modified whey protein isolate defined in claim 14 and sugar; and one containing flour, additional sugar and a leavening agent.

17. A process for making a food product comprising mixing a carbohydrate component with a modified whey protein isolate as defined in claim 11 and baking the resulting mixture.

18. A process according to claim 17 wherein the mixture is baked at a temperature of from above 425° F. to about 450° F.

19. A process according to claim 18 wherein the modified whey protein isolate is whipped to an overrun of from 900 to 1400.

20. A process according to claim 19 wherein the modified whey protein is mixed with the carbohydrate after whipping.
